(19) United States
(12) Patent Application Publication
(10) Pub. No.: US 2015/0101981 A1
(43) Pub. Date: Apr. 16, 2015

(54) ASSEMBLIES AND METHODS FOR TREATING WASTEWATER

(71) Applicant: Colin LENNOX, Altoona, PA (US)

(72) Inventor: Colin LENNOX, Altoona, PA (US)

(21) Appl. No.: 14/050,432

(22) Filed: Oct. 10, 2013

(51) Int. Cl. C02F 3/00

(52) U.S. Cl. CPC C02F 3/00
USPC 210/615; 210/446; 210/175; 210/162

(57) ABSTRACT

An assembly for treating wastewater may include a vessel having an inlet configured to direct wastewater into the vessel and an outlet configured to direct treated water out of the vessel. The inlet and the outlet are generally disposed at opposite ends of the longitudinal dimension of the vessel such that the wastewater generally flows in the longitudinal direction. The assembly includes at least one panel removably inserted into the vessel. The at least one panel extends substantially across a width dimension of the vessel, wherein the width dimension is generally perpendicular to the longitudinal dimension. The panel includes a biofilm-coated matrix that permits the flow of wastewater through the panel. The vessel and panel are sized and arranged such that the wastewater is exposed to the biofilm-coated matrix for a time sufficient to remove a desired metal from the wastewater.

### CROSS-REFERENCE TO RELATED APPLICATION

This application claims priority to U.S. Provisional Patent Application No. 61/______ entitled “Assemblies and Methods for Treating Wastewater” and filed on the same date as this application, the disclosure of the aforementioned provisional application being incorporated herein by reference.

### TECHNICAL FIELD

The present disclosure relates generally to the field of water treatment, and more specifically, to assemblies and methods for treating wastewater.

### BACKGROUND

Contaminated surface and subsurface runoff water from storm events and Acid Mine Drainage is a major cause of water pollution in urban, residential and agricultural settings around the world. During and after rainstorms, storm runoff picks up a wide variety of contaminants as it flows across the surface and then into private and public waters. Runoff that flows across roads and parking lots picks up oil, grease and metals from automobile discharges; it picks up nitrate and phosphate from fertilized lawns and golf courses; it picks up organic waste, herbicides and pesticides from agricultural sites; and it picks up grit and colloidal particles from all of these locations. From water sources impacted by mining, which include surface and subsurface flows, water can contain a wide variety of pollutants related to hydrologic fracturing for natural gas as well as acidified mine drainage water carrying heavy loads of dissolved metals. These contaminants pollute receiving waters such as streams, rivers and lakes, aquifers and groundwater unless collected (if possible) and treated prior to entering the receiving waters. In order to control negative water impacts, public authorities must provide methods for intercepting and treating these contaminated flows.

Stormwater can be treated by a variety of methods, including detention ponds, constructed wetlands, infiltration basins, constructed filters, and open-channel swales that vary duration, surface area, oxygen availability, and other biogeophysical chemical conditions. Treatment typically requires a combination of mechanical filtration (or settling) in combination with biological and chemical treatment. In general, mechanical filtration/settling removes the suspended particles, while biological treatment removes the nutrients and organic materials. The removal of nutrients, dissolved or oxidized metals and other contaminants by bacterial processes is commonly called Bioremediation and encompasses a host of biotic and abiotic mechanisms including, but not limited to, filtration, sequestration, and bioaccumulation.

Extensive research, experimentation and monitoring have been done in the U.S. within the past three decades to evaluate and improve the various methods of passive water treatment. Constructed wetlands, like natural “wetlands have a higher rate of biological activity than most ecosystems, they can transform many common [and uncommon] pollutants that occur in conventional wastewaters into harmless by prodcts or essential nutriens that can be used for additional biological productivity.” Treatment Wetlands, 2nd Ed. Kadlec and Wallace. Pg 4.

One method and/or construction (called best managemet practices or BMP's) that has shown excellent efficacy in treating stromwater is the “treatment swale”. According to the Center for Watershed Protection, the term “swale” refers to a “vegetated, open channel management practice designed specifically to treat and attenuate storm (water) runoff for a specified water quality volume.” A constructed wetland or treatment pond remains wet continuously and usually has water flowing through it at depth with free and open water. Subsurface constructed wetlands do not have open water and are generally made of gravel or cobble, allowing water to pass through without coming in direct contact with the atmosphere above. Due to the increased biological activity of wetlands and their heavy reliance on bacterial bioremediation for treatment, if certain conditions are met (ie. the physical environment/construction) to foster the purposeful growth of certain bacteria, nearly any form of water pollutant, from nutrients to metals (not not salts), can be removed from an impacted water source.

Considering excess nutrients and organic and inorganic sediments, particles are mechanically (abiotically) filtered, while nutrients are bioaccumulated by naturally occurring heterogenous (many species) bacterial colonies (biofilm) attached and growing on the surfaces of vegetation and soil particles. The biofilm uptakes, cycles, and converts excess nutrients (such as ammonium and phosphate) and decopose organics (such as manure and plant detritus) during its normal metabolic activity. More nutrients means more bacterial biofilm meaning more primary productivity. For example, certain bacteria use ammonium as an energy source, and convert it to nitrite while other bacteria then convert nitrite to nitrate during their metabolic processes. All bacteria require lesser, but no less necessary, amounts of phosphate, Potassium and other micronutrients to survive and reproduce. The process of nutrient uptake by Chemo-heterotrophs (bacteria that require outside sources of inorganic chemicals for metabolism) alongside Macrophytes (water plants) are the primary source of passive (only natural energetic sources) bioremediation in Lentic (ponds, wetlands, lakes), lotic (streams, rivers), and marine environments (salt water bodies like estuaries and the oceans).

These heterogenous colonies of bacteria secrete sticky films that support and protect the bacterial colonies, giving them resistance to a variety of harmful factors such as sunlight and toxic chemicals, increasing their overall survivability. This biofilm, which can be found on any surface on the planet more than a few minutes after its exposure to an open environment, provides structure for the various microbes to grow, metabolize, and reproduce on and within, requiring only a surface to attach to and the available ingredients of life. The microbes reproduce, continue to excrete EPS (extra polysacharidal matrix) in the form of a colloid (like mayonaise), and the colony grows and evolves through the process of Succession (the sequence of organisms generally from first and homogeneous leading to stable, mature, and heterogeneous) to better fit its environment while adapting the environment to better support the growing colony.

Biofilm is responsible for up to 50% of the bioremediation within a natural wetland, while perched on what ever natural and haphazard surface area is available, mostly the marcophytes (plants) and the available pourous benthic structure at the bottom. Constructed wetlands provide more surface area for bacteria with more plants in open water embodiments or gravel in subsurface flow wetlands, increasing the wide range of potential pollutants to be remediated. To increase surface area is to increase the overall availability of bacterial biofilm that can cycle and treat for pollutants, reducing the size and increasing the effectiveness and capabilities of the treatment vessel.

There are numerous examples in the prior art of “treatment in a box” types of remediation systems, wherein polluted water is passed through porous and permeable treatment media that are encapsulated within various types of containers. Examples of these types of systems are disclosed in Vandervelde et al. (U.S. Pat. No. 5,281,332), Towndrow (U.S. Pat. No. 6,858,142) and Kent (U.S. Patent Application Pub. No. 2008/0251448). In these and other similar examples of prior art, the containment systems are comprised of rigid exterior walls and are not designed to be fitted into channels. There is one example in the prior art (Rainer, U.S. Pat. No. 5,595,652) of a treatment structure that is designed to snugly fit into a pipe, thereby preventing by-pass of water around the structure. This device is a simple tubular container filled with pieces of sponge that expand when exposed to water. Although this device may be suitable for use in enclosed pipes of circular cross section, it is not readily adaptable for use in open channels of non-circular cross section, particularly if the channel surface is irregular. For example, the expansion of this device would tend to cause the device to “pop out” of a trapezoidal channel as the device expanded because it comprises no means of attaching the device to the channel walls.

Although conventional open and covered water treatment wetlands are both useful for the treatment of contaminated stormwater, each has numerous drawbacks. For example, open water bmp's are poorly accepted in residential settings due to the nuisance surface flows that promote noxious pests such as mosquitoes and may produce drowning hazards for children, while subsurface flowing wetlands have the disadvantage of requiring relatively disruptive and expensive earth work when they eventually “plug up”. Biofilm only grows on the outside of gravel, the largers the gravel, the less surface area but also slower plugging rates. In each case, they are generally much bigger than needed because the materials used for surface area upon which the remediating biofilm grows is not optimal for the creation of surface area. With smaller gravel comes reduced flow and greater likelihood of clogging, bringing its own host of issues. When plants are the primary form of surface area creation, the very thing that provides a surface dies and regrows every year and can only grow in certain environments. Depending on the treatment train in acid mine adrainage, plants can actually reduce or stop the remediation of metals like Manganese if left to decay in the bmp. When a treatment system silts in over time from the decomposition and settling of dead organic material and/or settled metal precipitates, it must be cleaned out to restore certain hydrologic properties (such as flow), this must usually be done with heavy equipment, destroying the plants, and removing the majority of the surface area in the constructed treatment wetland, rendering it functionally useless in terms of remediation until the plants re-grow.

The present disclosure incorporates the advantages and eliminates the disadvantages of each of these prior art swale systems, while also incorporating several desirable new features that are not present in any type of conventional best management practice.

It may be desirable to provide an assembly and method that is designed and constructed of biophysical environments on the macro and micro scale, for the purpose of the remediation of acid mine drainage water and land using microbial substrate in arrangement that maximizes microbial colonies of biofilm for the purpose of filtering, bioremediating, and/or biosequestering metals and nutrients associated with agriculture, urban waste water, and acid mine drainage remediation processes. The specific conditions of the polluted natural or manmade source, whether it be point source or non-point source, are each unique and have complex bio-geo-chemical conditions, typically with the source of the pollution being a mining disturbance of some form in the past or present, ongoing agricultural activities, and/or urban waste pollution.

### SUMMARY

According to various aspects of the disclosure, an assembly for treating wastewater may include a vessel having an inlet configured to direct wastewater into the vessel and an outlet configured to direct treated water out of the vessel. The inlet and the outlet are generally disposed at opposite ends of the longitudinal dimension of the vessel such that the wastewater generally flows in the longitudinal direction. The assembly includes at least one panel removably inserted into the vessel. The at least one panel extends substantially across a width dimension of the vessel, wherein the width dimension is generally perpendicular to the longitudinal dimension. The panel comprises a biofilm-coated matrix that permits the flow of wastewater through the panel. The vessel and panel are sized and arranged such that the wastewater is exposed to the biofilm-coated matrix for a time sufficient to remove a desired metal from the wastewater.

In some aspects of the disclosure, a method for treating wastewater may include the step of removably inserting at least one panel into a vessel, wherein the at least one panel extends substantially across a width dimension of the vessel and comprises a biofilm-coated matrix that permits the flow of wastewater through the panel. The method further includes the steps of directing wastewater into the vessel, treating the wastewater, while in the vessel, by directing the wastewater in a longitudinal direction through the at least one panel, and directing treated water out of the vessel. The longitudinal direction is generally perpendicular to the width dimension, and the vessel and panel are sized and arranged such that the wastewater is exposed to the biofilm-coated matrix for a time sufficient to remove a desired metal or pollutant from the wastewater.

### BRIEF DESCRIPTION OF THE DRAWINGS

In the drawings:

FIG. 1 is a diagrammatic illustration of an exemplary assembly for treating wastewater in accordance with aspects of the disclosure;

FIG. 2 is another diagrammatic illustration of the exemplary assembly of FIG. 1;

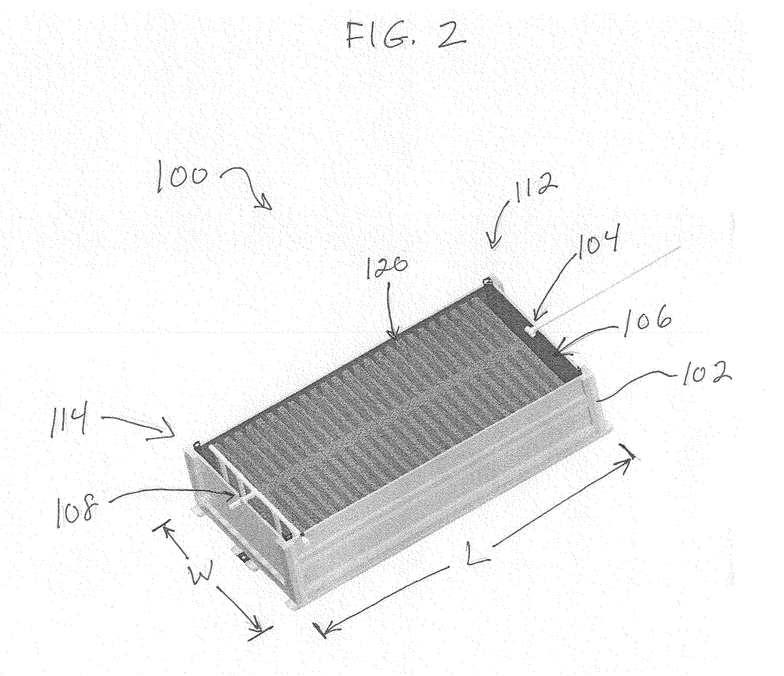

FIG. 3 is a diagrammatic illustration of an exemplary heat exchanger for use with assemblies according to the disclosure;

FIG. 4 is an illustration of the redox ladder; and

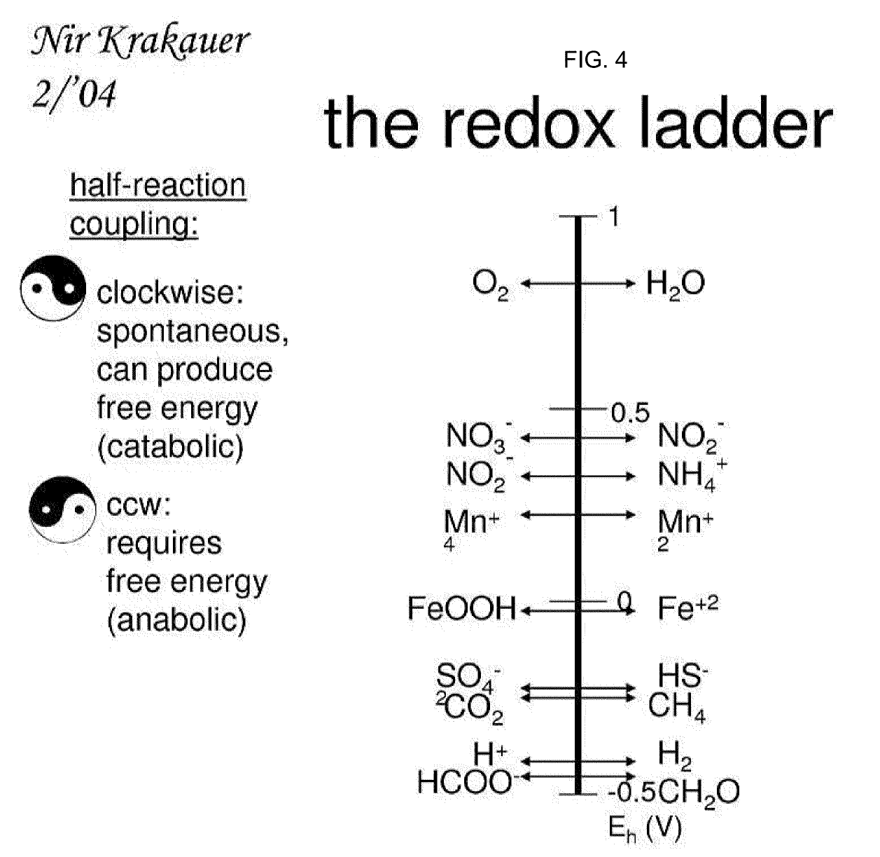

FIG. 5 is an illustration of an exemplary sequence of processes of the redox ladder.

### DETAILED DESCRIPTION

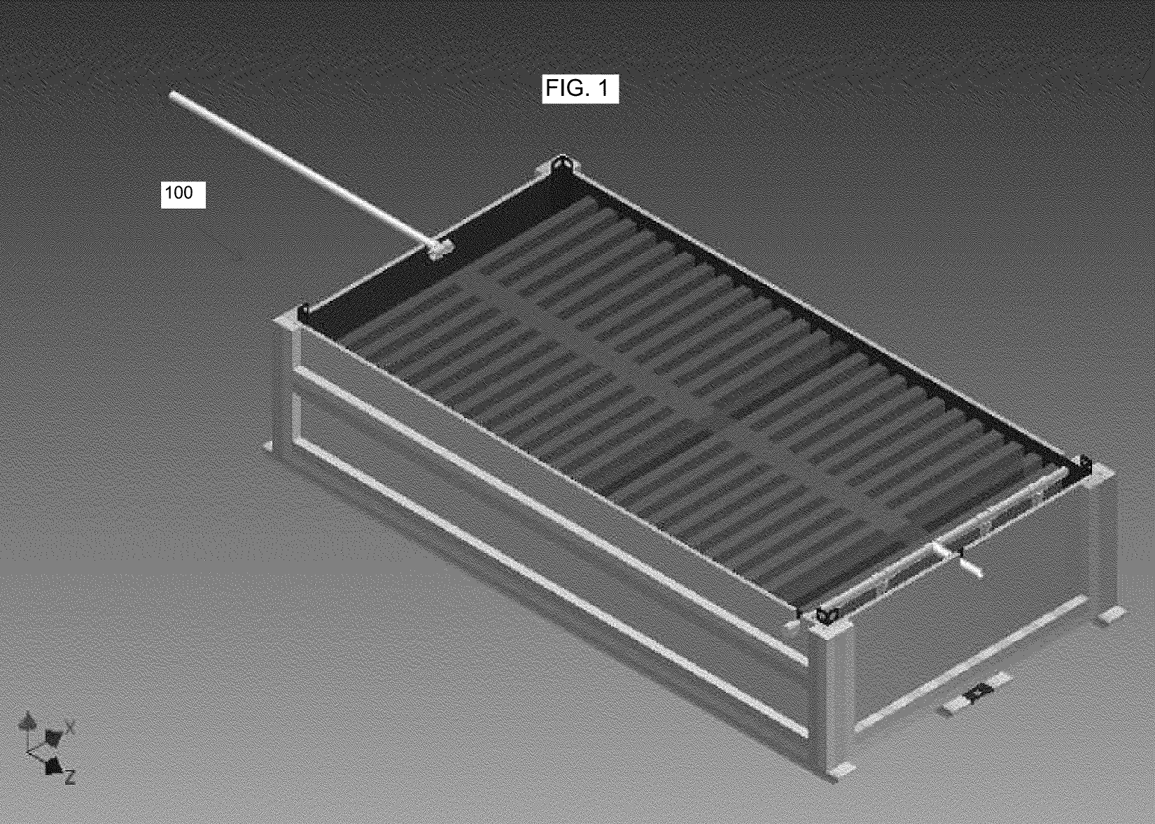

FIG. 1 is a diagrammatic illustration of an assembly 100 for treating wastewater. The assembly 100 may include a vessel 102 having an inlet 104 configured to direct wastewater into the volume 106 of the vessel 102 and an outlet 108 configured to direct treated water out of the vessel 102. The inlet 104 and the outlet 108 are generally disposed at opposite ends 112, 114 of the longitudinal dimension L of the vessel 102 such that the wastewater generally flows in the longitudinal direction generally shown by the arrow in FIG. 1.

The assembly 100 includes at least one panel 120 removably inserted into the vessel 102. The at least one panel 120 extends substantially across a width dimension W of the vessel 102. The width dimension W is generally perpendicular to the longitudinal dimension L. The panel 120 comprises a matrix 122, which facilitates the presence of a biofilm coating. The matrix 122 is sufficiently porous that it permits the flow of wastewater through the panel 120. The vessel 102 and the panel 120 are sized and arranged such that the wastewater, as it flows through the vessel 102 from the inlet 104 to the outlet 108 is exposed to the biofilm-coated matrix for a time sufficient to remove a desired metal from the wastewater.

It should be appreciated that the vessel 102 has a length/volume chosen to utilize the Redox ladder, discussed in more detail below, for treatment of the wastewater. In some aspects, a single vessel 102 may be used. In other aspects, a system may comprise a plurality of vessels 102 in sequence. In either case, the purpose is to utilize microbial biofilm naturally grown and attached to an appropriate synthetic, inert substrate arranged, sequenced, or positioned to specify and maximize microbial biotic and abiotic conditions for the purpose of water decontamination or pollution remediation of wastewater. It should be understood that the wastewater may have been caused by negative consequences of mining, nutrients, storm water, and associated urban runoff directly and temporally and/or as post operational reclamation.

According to various aspects of the assembly, the panels may comprise organic or synthetic microbial substrate panels. The panels may be positioned at an angle to flow ranging totally perpendicular to totally or nearly parallel. In some aspects, the assembly may include a plurality of inlets 104 and/or a plurality of outlets 108.

In operation, the assembly for treating wastewater may be used in a method for treating wastewater, that is, polluted water and its specific biochemical geospatial conditions. The method may include the step of removably inserting at least one panel into a vessel, wherein the at least one panel extends substantially across a width dimension of the vessel and comprises a biofilm-coated matrix that permits the flow of wastewater through the panel. The method further includes the steps of directing wastewater into the vessel, treating the wastewater, while in the vessel, by directing the wastewater in a longitudinal direction through the at least one panel, and directing treated water out of the vessel. The longitudinal direction is generally perpendicular to the width dimension, and the vessel and panel are sized and arranged such that the wastewater is exposed to the biofilm-coated matrix for a time sufficient to remove a desired metal from the wastewater. This process may be carried out with a single vessel or a series of vessels containing the substrate through which the water is channelized remediating pollutants in the process.

It should be appreciated that the actual process of determining the final form and additive manipulations to achieve increased system efficiency through project assesment and design criteria, the answers of which determine the vessels passive and active embodiment and effluents: “the design question matrix”, all must be answered and considered to come up with an effective, efficient, system:

For example, the physical site characteristics should be considered to determine how the assembly for treating wastewater should be configured in order to receive the polluted water and expel treated water under the force of gravity. The assembly may be a newly designed/constructed, or a retrofit to an already-existing water treatment system. In addition, the pollutant loadings, purities, and overall volume of wastewater to be treated must be determined in order to design an efficient, effective, and durable system for wastewater treatment. The system designer should also consider how many inches of storm surge will need to be retained before an overflow is triggered.

What are the potential active energy inputs and what are their efficiency thresholds compared to system effectiveness and complexity? For example, is it worth running in electricity to a site to make it more effective through the use, in some manner, of the electricty (adding O2 or against gravity circulation pumps). Similarly, what are potential passive energy inputs that can be harnessed, such as gravity/water head pressure, sun, artesian water pressure, geothermal heating cooling, or O2 adding trompes.

According to aspects of the disclosure, it is desirable to maximize the surface area of the panels relative to the volume of the vessel and the flow rate through the vessel. For example, in slower flowing environments (5-50) gpm, a matrix with a tighter weave may be more useful, whereas higher rates of flow may require matrix with larger pore space to allow for increased flow without backing up portions of the system or causing short circuiting by forcing the water over top of the matrix panels.

According to various aspects, the designer may desire to harvest mineral deposits or other materials via the assembly when such harvesting provides realistic rates of return for any potential increased system complexity relating to access, labor, and commodification. This decision of course depends on the potential harvestable materials. It may also be based on the available capital and/or in-kind investments.

It should be appreciated that the design and, ultimately, the measurement of success of assemblies according to this disclosure may be based on various quantifiable and qualifiable (sustainable) terms. For example, in an urban environment the use of anerobic bioreactors for the purpose of sulfur volitization and removal would not go overwell with the locals, but on abandoned mines lands sulfur smell in the air is not a concern. Similarly, a system near populations can be designed to provide aesthetic or beneficial uses: the cleaned effluent waters can be used for urban agriculture, then cleaned again through the same system, cycling and recycling the water (like a populations synthetic kidney and very useful in dry climates or where access to clean water is limited.

Also, the evaluation of the assembly may take into consideration the long term maintenance and labor costs taken out to the 50+ years, with integrals of return, operation, and maintenance every seasonally to yearly. Acid mine drainage seeps and sources can flow for decades to centuries, requiring a permanent operation and maintenance schedule that must be fullfilled.

According to various aspects, the physical site characteristics may include head, topography, soils, retention, vegetation, annual rainfall, heavy rain events and flooding history, erosion and sedimentation plans, latitude for purposes of solar input/shading, and high and low temperatures. The pollutant load and existing environmental characteristics, biotic and abiotic, should be determined, as well as condition of the water, loading concentrations, space, volume, biologic conditions, geologic conditions, hydrologic conditions, atmospheric conditions, concentration variation from dilution, and the like.

In some aspects, procedural manipulations may be used to force pollutants to be remediated. Some procedural manipulations may include the addition of chemicals, or bioligical requisites and active energy sources to speed treatment times or reduce chemical or energetic barriers.

Theoretically, the disclosed assemblies and methods can treat contaminated water for anything that a natural or constructed wetland can treat, which is basically anything. It should be appreciated that volumized matrix based synthetic wetlands sequesters, filters, or remediates, any or all of pollutnat forms including but not limited to total suspended solids, Fe, Mn, Cu, Zn, Al, Ammonia, Nitrite, Nitrate, Phosphate, pH buffering (to name just what the inventor has personal experience or presentable evidence or literature for. These pollutants are can be predictably removed dependent on their loading, flow, volume, and reduction oxidation potential with this system so that certain metals or contaminants will be remediated and or collected in predictable succession.

As described above, an open top or closed vessel or vessels in a natural or constructed environment through which contaminated water passes that contain synthesized inert, synthesized reactive, or biologically reactive panels or curtains 120, which function as microbial substrate surface area. The panels 120 may be placed at an angle or perpendicular to water flow. The presence of the biofilm on the panels or curtains provides pollution remediation through the active and passive properties of the microbial biofilm growing on the panels which are analogous to biofilms' roles and functions in a natural or constructed wetland.

The assembly 100 can remediate water impacted by mining, agriculture, or urban storm water or sewerage contaminants. The assembly 100 sequesters the pollutants in the vessel for cleaning and/or reclamation of the materials in the case of usable saleable metals, sludges, or muds. The assembly 100 can have qualities of lentic (pond/lake) and/or lotic (river/stream) flow characteristics dependent on the residency time and vessel form and volume. However, due to the high biofilm biomass, lower residency times are required to do the same remediation as systems with the same functions that do not contain microbial substrate panels or curtains. Flow must still be slow enough to maintain the volume of the free floating biofilm. Otherwise, the biofilm may be knocked off, reducing bio-volume if the flow is too fast. The panels 120 themselves promote slowed flow and increased retention as water is strained through them and the biofilm interacts with the water and the loaded contaminants, just like a natural wetland.

It should be appreciated that existing remediation assemblies can be retrofit with assemblies 100 disclosed herein. Due to the variety of forms and physical embodiments that are used for remediation, a broad range of applications exist through the addition of synthetic, inert, or biologically reactive microbial substrates. The physical environment of the substrate is optimized for the preference and growth of specific microbial masses, called biofilm. These microbial masses, along with the physical structure of the inert substrate, filter, bioremediate, and biosequester specific pollutants dependent on the specific environment required and the vessel construction predicated by the to be created micro-macro environment or synthetic niche.

The biofilm that grows and fills the panels 120 and the volume between the panels 120 are naturally occurring in the environment and thus have no absolute need for inoculation by lab grown or engineered microbes. Of course, a vessel can optionally be inoculated by placing a “seed” panel from another established system at a new systems influent, but this is not necessary. The introduced mature biofilms will quickly help to establish the new system. It is possible that certain biofilms from certain systems, due to a synthetic niche's maximum treatment potential, may evolve or change to be more effective overall, than biofilms growing on natural environments. For example, a “seed” systems may be chosen for its ability to foster a certain Manganese oxidizing bacteria in the film that has evolved or diversified/homogenized to take maximum advantage of its ability to oxidize Manganese exactly because the niche which it would grow in naturally has been designed to promote that particular biofilms growth. This forced succession could change the make up and diversity of the biofilm, which is then more effective at its purpose. This technique of synthetic succession would grow a biofilm that has the efficiency of a laboratory planktonic microbe but the defenses and heartiness of a naturally occurring biofilm.

In some aspects, microbially mediated environments can be used for the maximization of biofilm biomass, for example, synthetic inert biofilm substrate, towards the purpose of remediation. Synthetic niches can be designed and placed in sequence of the treatment train to favor certain microbes that remediate different pollutants dependent on their re-dox potential. Thus, the panels 120 may support the growth of many species or just one. For example, a heterogeneous biofilm mass can treat for a variety of pollutants, but only sulfate reducing bacteria species will reduce sulfur.

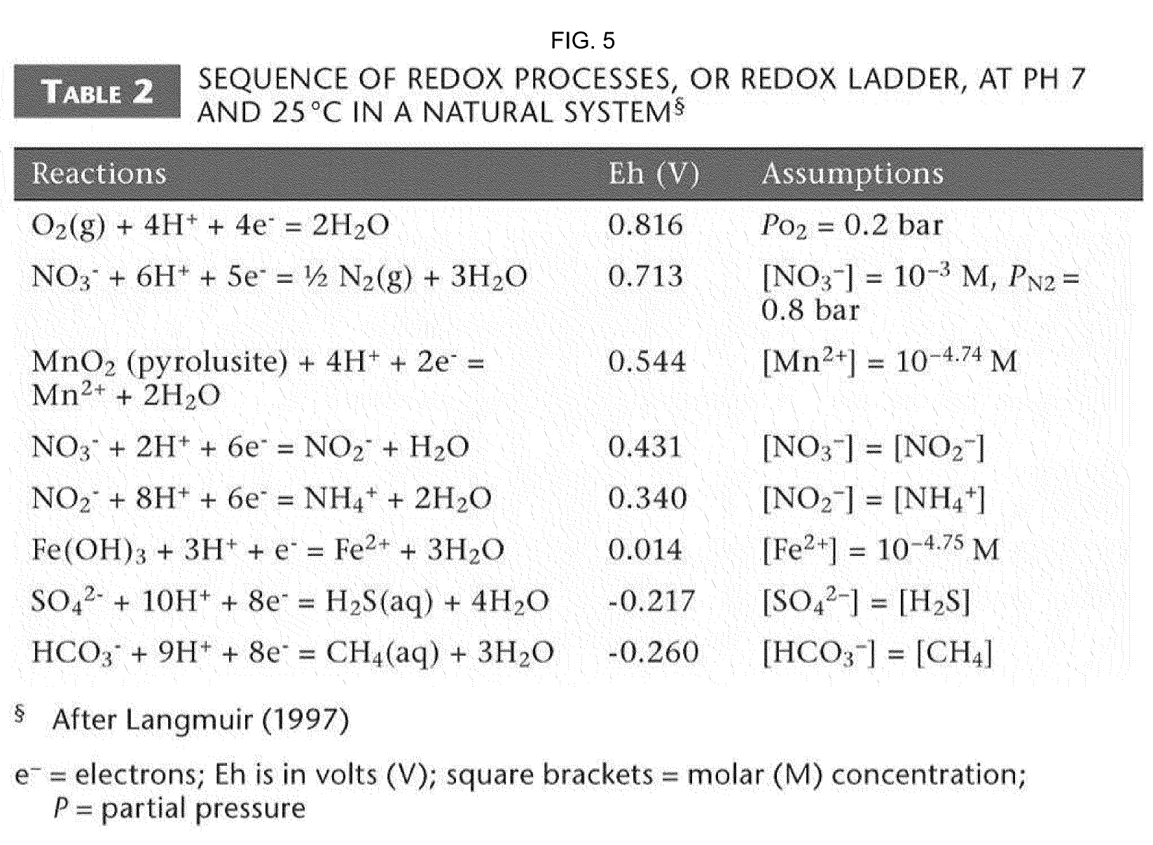

The assembly 100 may be configured to provide the requisite synthetic niches required to remediate different pollutants dependent on their re-dox potential based on the redox ladder of pollutant remediation, as illustrated in FIGS. 5 and 6. In some aspects, one vessel or a series of vessels (i.e., niches) may be provided to remediate pollutants in order of their redox potential, from highest potential to lowest potential. For example, for contaminated mine water, the remediation order may start with nutrients first, then iron, then manganese, then sulfur. Each pollutant must be substantially removed from the contaminated water for the next pollutant to be remediated. For example, in the 2012-13 Glasgow and Flight 93 Wetland BioReactor studies carried out by the inventor and coroborated by literature, Manganese will not auto-catalyze unless all of the dissolved Iron in the water is below approximately 0.35 mg/L (and other factors like pH, alkalinity and other inhibiting pollutant concentrations (everything else “higher” in the RedOx ladder are removed). Generally, after Fe concentrations have dropped below this amount the Mn is then free to autocatylze and drop out quickly from solution in an oxidized form.

Thus, it should be appreciated that if a vessel 102 with panels 120 is long enough/has the necessary volume to residence time, all pollutants will come out in re-dox order naturally, so long as portions/volumes of the length are designed to provide the necessary synthetic niches. For example, a distal end of the vessel 102 would need an anoxic environment (i.e., no O₂) for sulfur reducing bacteria to grow so that sulphur can be removed.

The panels 120 may include an arrangement of microbial substrate of varying and specified width and depth to fill totally or partially a perpendicular, partially parallel, or angled plane in relation to the flow within the vessel 102 for the purpose of contaminant remediation. In some aspects, the panels 120 may comprise curtains.

According to some aspects, the vessel 102 may comprise a trench, a pipe, or any long linear embodiment acting as lotic flow (i.e., stream/river flow) where the width is significantly less as a ratio to the length. Such a vessel configuration acts to have a greater and more distinctive separation of pollutants as they are pulled from the contaminated water (from influent to eventual effluent) by the panels 120. The vessel should be easy to clean by hand or machine and more accessible (e.g., 4-6 ft wide).

In some aspects, the assembly 100 may include multiple vessels 110, each with its own influent and effluent. It should be appreciated that a first vessel 102 is put into use, and the second and subsequent vessels are brought on line only when flow volume increases. The flow through each vessel may cascades over wiers or through pipe manifolds to the next vessel when overflow occurs. This arrangement allows the treatment to be confined to as few panels 120 and/or vessels 110 as are needed in order to reduce maintenance, cleaning, and replacement of panels if/when their lifespan is achieved. Switchbacks on a steep or contoured site compress linear (for example, one long trench) treatment system into very small spaces. It should be appreciated that a plurality of vessels, where desirable, can also be stacked vertically where footprints are very tight but elevation is available. One or more of the plurality of vessels can be buried or built as a tower (to be insulated if needed).

In still other aspects, the assembly 100 may include wide embodiments where the width of the vessel is greater than the length. In such embodiments, flow across and through the vessel may be normalized to reduce slow/inefficient zones by use of a manifold of pipe influents and effluents.

In yet other aspects, the vessel may comprise a smooth bore or corrugated pipe and have matrix discs inside that are spread relatively evenly along the length of the vessel and attached together by a cord, rope, or rod which may be pulled out and reloaded from influent to effluent the same way. The bore or pipe can be plastic or concrete.

In the case of corrugated pipe, the action of removal, if the discs are made to equal the diameter of the outside corrugation, act as a scrubbing/cleaning action of the collected sediments in the bottom troughs of the corrugation, which act as useful collection points. The deposited precipitate and sediments flow out en masse as the matrix “squeegee” is removed and passed through several times, the action of which also breaks loose the accumulated material on the matrix discs, cleaning them simultaneously.

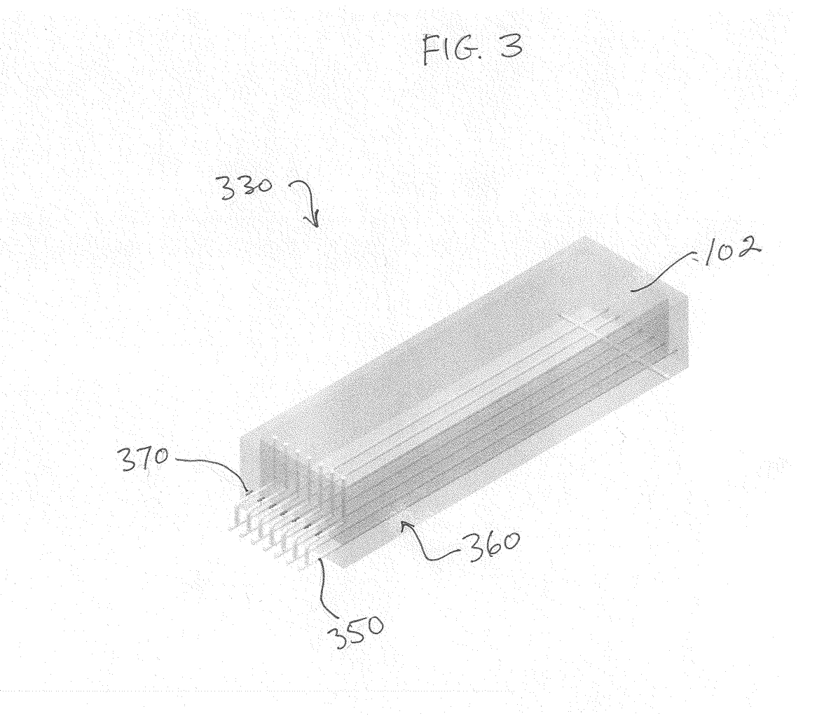

Referring now to FIG. 3, in a trench embodiment, a heat exchange assembly 330 may include effluent pipes 350 can be buried in the ground or concrete 360 below the trench/vessel 102 to act as in-floor radiant heating exchanges. The heated effluent water's heat energy conducts to the bottom and/or sides of the trench. The warmer effluent exchanges its heat energy with the cooler influent as it passes underneath the trench/vessel, thereby warming the influent water and microbes while also cooling the effluent and, thus, reducing concerns over thermal pollution. For example, concrete can be poured directly over the pipes and incorporate as heat exchanger or use a prefabricated concrete form that can be delivered and placed on site, plumbed together, and insulated earth materials or mass by partially burying the individual heat exchanger for the purpose of insulation/thermal mass.

In the situation where pvc pipes of the heat exchanger are laid and poured into place as one long trench (e.g., 20+ ft. long), a straight and easily accessible clean out, flush out plug should be added along with a shut off valve 370 to control each individual outflow pipe. A long ramrod clean out scrubber can then be used to clean and clear out any obstruction, which may develop over time.

The manifold will normalize the effluent cross section, and by adding shut off ball valves 370 each pipe can be selectively changed and/or shut off for cleanout and effluent rates per pipe, can be adjusted, thereby tweaking the manifold to even out flow across the profile. For example, ball valves may be slightly closed on effluent manifold pipes that are connected to the middle of the trench while the outside manifold valves are open full to allow for more flow.

It should be appreciated that larger pipes may be set into the sides above the designed treatment draft water line so that during flood events the system does not overflow the banks of the trench. For example, 2″ pipes may be used as effluent, while 3-5″ pipes may be used as overflow.

In some aspects, the assembly 100 may include stepped treatment cells that follow the contours of the land, for example, a long trench with impermeable barriers blocking flow that act as weir steps or boat locks to increase individual retention and maintain the water level to take advantage of all treatment potential from panels even during low flow. High flow events can open baffles at the bottom of the steps to allow for greater flow (through or below step weir) without adding additional height to sides. This will decrease resident time of individual treatment cells but allow for emergency/high flow capacity.

In an exemplary assembly 100 that is particularly large or in a natural or urban environment that becomes capable of supporting delicate or sensitive species such as trout due to its ability to clean the influent to tolerable levels, it may be beneficial to incorporate trout ladders and other methods of ingress/egress for natural wildlife. Trout ladders can be added such that holes and passages are built into the matrix panels so that aquatic life can pass through. To reduce the increased flow and short circuiting this presents, it would be useful to place the passages in an arrangement such that they are as far away from each other as possible, creating an extreme back and forth pattern (e.g., all the way from one side of the trench or embodiment to the other).

In some aspects, the matrix 122 may comprise a parachute matrix for capturing and screening contaminants in a consistent current without creating a total barrier to flow. In such an embodiment, the curtains or panels 120 do not or cannot effectively touch both sides for reasons of state, federal, or local regulations or environmental practicalities. An example would be many matrix parachutes in the Ohio River at strategic locations that would not block passage for boats but still provide some level of non-point source treatment, primarily of nutrients and sediments. Hard points that anchor a matrix treatment sail into a current, the channel of which is too wide to stretch matrix directly across or to provide treatment without blocking a natural channel, and the sides of which act as the vessel that determines a flow direction

In some aspects, a vessel or series of vessels 102 with biofilm substrate may be arranged with a singular or a plurality of influents and effluents so as to create a synthetic niche conducive to pollutant remediation based on available or introduced microbes. Circulation internally within a vessel independent of influent and effluent or between different embodiments, in pulses or constant flow, may aid in different portions of the treatment process where one embodiment may contain a beneficial component to a previous or following embodiment. For example, activated sludge waste treatment systems may introduce microbes from one step of the treatment train to another. Some exemplary vessels 102 may include influents and effluents that can be used for water and contaminant recirculation through a singular vessel substrate or a plurality of vessel substrates.

In some aspects, a vessel 102 may include multiple inlets and outlets with flows either vertical or horizontal for the purpose of increasing residence time/and or surface area contact within the vessel using synthetic inert microbial substrate or other diversion constructions or devices for the purpose of flow diversion. A vertical or horizontal flow embodiment can also be used to remove O₂ without the need for additional nutrients while eliminating O₂ diffusion. A vertical or horizontal flow embodiment can also be used to add O₂ by forcing the water down through matrix, then back up to the surface for the diffusion of more O₂ that would be used up by passing through the matrix going down.

A Manifold made of pipes of influents and effluents with many holes can be used to normalize flow within a vessel 102 to maximize matrix surface contact to water (making many influents and effluents out of one point source in order to spread flow across a whole section of an embodiment). Such an arrangement may reduce “dead-zones” of treatment in the process as water moves through the panels, thereby more effectively utilizing the available surface area/biofilm if a wider embodiment is desired or useful.

In some aspects, the assembly 100 may include a mobile or transportable modular design to be placed on site or moved for emergency response. Mobile emergency embodiments can be pre-inoculated and ready for treatment in the case of oil or fracking water spills or contamination where time and immediate treatment is necessary to preserve public or ecological health. Mobile emergency embodiments can be made energetically active by providing an electricity source to units that circulate, add heat, add oxygen, nutrients, pH amendments, and the like. Such a mobile and transportable unit must be size and arranged light enough and/or small enough to move to a site from a flatbed truck, while at the same time being strong enough to support its own weight when filled with fluid and operating.

In other aspects, treatment trains may also contain flushing and de-watering ponds/tanks for sludge/mud capture during cleaning where:
a sludge pond is emptied or drained from previous clean out;
flow is shut off to the trenches or vessel(s), and the panels are cleaned in the remaining water within the vessel(s) and panels are temporarily removed;
water in the vessel(s) or trenches are drained to the empty sludge pond;
panels are replaced and flow and treatment resumes;
sludge pond material is allowed to settle entirely, and the water is drained from the top down to the level of sludge; and
sludge is removed and the pond is emptied for next clean out if necessary.

It should be appreciated that the panels 120 can be cleaned by shaking them vigorously within the vessel 102 during flow or after flow has been turned off. The panels may also be removed, cleaned, and replaced for reuse by simple and very accessible means. In some aspects, the panels 120 can be vibrated and shaken vigorously by a machine that drains the accumulated materials back into the vessel 102 for sludge accumulation and removal. For example, a machine with vibrating arms may be positioned to contact and shake the panels while they are still in place in the vessel 102.

Pressure washing the panels 120 may be the fastest and most effective means of thoroughly cleaning the panels. Thicker panels are be more difficult to clean, making effective cleaning of a panel by any means a factor of its thickness. This then means that a re-useable panel can only be as thick as the method that will be used to clean it. For example, if panels are only an inch thick and not clogged with metal precipitate, simple vigorous shaking are all that is needed. But for thicker panels and/or panels clogged with a metal precipitate, a pressure washer is needed to effectively clean the panels. Panels can also be partially cleaned by increasing flow to the point that materials begin to break free and are flushed down stream to a holding or sludge pond for separation and de-watering. In addition, the physical flexing and bending of the panels to loosen accreted materials before pressure washing increases the effectiveness of the cleaning process. For example, a physical embodiment with rollers (like those used before clothes dryers to squeeze and wring out water) can be used to mechanically loosen materials hardened on the panels without damaging the panels themselves.

In some aspects, non-permeable flanges or insets may be disposed along the length of the vessel 102 at bottom and/or sides thereof. Such flanges or insets may accept, space out, hold in place, and prevent “short circuiting” by going around/under panels which may otherwise reduce system treatment effectiveness and residence time.

It should be appreciated that some aspects of the assembly 100 may include additional matrix between the panels. Such matrix may comprise loose, free, and/or non-bonded matrix. Such additional matrix may provide additional surface area to an assembly that may otherwise be experiencing short-circuiting or in need of additional surface area to achieve treatment requirements. Such additional matrix can be open or free/loose fiber that when compressed achieves the same relative surface area to volume ratios as the basic/standard embodiment matrix made of recycled plastics. Such additional matrix may comprise shredded or separated coconut bristle coir or recycled shredded carpet fibers. In some aspects, the additional matrix may be disposable. This additional and/or disposable matrix-like material can be used to fill in areas between panels and increase total biomass and biovolume of the system but will have to be removed during cleaning and either cleaned and re-used or disposed of.

It should be appreciated that in-situ active and passive energetic sources may be utilized to maximize the specific biotic and abiotic characteristic conditions within the vessel to maximize biofilm remediation potential of pollutants. How an assembly is designed and integrated determines what it will remediate and where/when such remediation will occur in the treatment train. Optimization of the assembly 100 will determine how effective and efficient the assembly 100 will be at performing the task of remediation (e.g., getting the most out of the panels by manipulating the embodiment environment).

For example, some embodiments of the assembly 100 may add and/or remove oxygen, heating or cooling, radiation (sunlight), protection from seasons (subsurface or insulated), pH adjustment through lime or caustic soda, nutrients, carbon source, and/or flow, residence time, and/or volume. Some embodiments may include a mechanical system for 0₂ or 0₃ introduction, piping with bubblers, or venturis for treatment before or during remediation residence, to aid in microbial metabolism, and/or to encourage additional metals precipitation. Various embodiments may include in-situ micro-hydro, solar panels, aerators, pumps for re-circulation, geothermal, other forms of heating or electricity generation. Some embodiments add covers for insulation, subsurface insulation (e.g., deeply buried trench that is still open topped or a buried pipe with panel disks that can be removed, cleaned, and replaced), and/or thermopane glass for IR capture and greenhouse effect. Various embodiments may include non-permeable flexible panels/curtains fronted or backed by a biofilm substrate in the presence of large flow where mixing and surface contact is necessary, for example, in deeper vessels with much larger flow (50+ gallons per minute) or to increase residency time while limiting slow flow zones within the vessel (e.g., lentic or pond-based retrofits where the pond is deep and mixing is required).

In some aspects, the assembly may be positioned depending on the site location such that the panels run parallel to sun's direction, allowing greater light penetration, with shallow vessel depth and wide distribution of flow through a weir influent or manifold and a manifold effluent to normalize channel flow through the panels both vertically and/or horizontally. Some embodiments my include reflectors to focus more light energy on the biofilm supporting panels and free water biofilm. For example, a reflector may be angled in accordance to the local latitude so that the summer apex at noon is 10 degrees less than the reflectors top angle summer peak (i.e, the top of the trench that is lined with reflective material which is angled ten degrees more than the suns peak). For example, at 40 degrees north or south latitude the top angle of the concave reflective surface should be more than 40 degrees to whatever is a maximum so that all energy is reflected into the biofilm and water.

In some aspects, a thermopane covering may be used to increase temperature and insulation properties of the embodiment to warm the water passively.

In an embodiment designed for anerobic conditions, water warmed through the use of a clear “greenhouse/thermopane” covering that is air tight will speed the removal of dissolved O₂. Aerobic bacteria will use the last of the O2 available after the water to be treated has entered the anerobic embodiment, warm water temperatures hold less dissolved O2 and speed microbial metabolism, ultimately requiring less matrix volume to remove the last O2 before anerobic conditions are achieved to create a Reducing environment.

In some aspects, the vessel may be painted black or a black pond liner may be used for additional thermal absorbance.

Embodiments utilizing ambient subsurface earth and water table temperatures (open and closed loop system) averaged at 45-55 degrees Fahrenheit at least 1 meter underground may utilize the natural ambient heat potential to increase microbial metabolism during climates and/or seasons that otherwise shut down microbial metabolism (e.g., anything less than about 40 degrees F.). Minimum operating temp for a geothermally linked system is now always ground water temp.

Running a system subsurface can also cool water that has been heated up so that thermal pollution in the receiving water body is not a concern.

In accordance with aspects of the disclosure, use of the assembly 100 is based on the RedOx ladder sequencing that first heats, passively or actively, the influent or effluent of water for the purpose of maximizing biofilm metabolism and then uses geothermal cooling to lower water temperature to reduce thermal pollution upon re-release to a natural environment in relation to 0₂ concentrations. The cooling may be achieved via either a radiant floor heat exchange unit or just by buried pipes cooling the effluent underground.

In accordance with the present disclosure, anything that a natural or constructed wetland can treat for may, theoretically, be remediated by the assemblies 100 of this disclosure. Thus, basically anything, except for salinity, may be remediated. According to various aspects of the disclosure, and supported by experimentation, applicant has direct evidence and/or has observed through experimentation that volumized matrix-based synthetic wetlands sequester, filter, or remediate (biotically or abiotically) the following: total suspended solids, total dissolved solids, Fe, Mn, Cu, Zn, Al, Ammonia, Nitrite, Nitrate, Phosphate, and pH buffering through biological production of alkalinity through decomposition.

Assemblies according to the disclosure may be designed to maximize the efficiency of metals bioreactors, nutrient bioreactors, urban run-off bioreactors, combination bioreactors for multiple biologics of multiple species traits and niches with multiple purposes contained within the same vessel (re-dox), multiple steps of the redox ladder performed within the same vessel, bioreactor trench design, and/or anaerobic or reducing sulfur bacteria bioreactor.

Matrix material to be used in bioreactors includes, but it not limited to, all materials that have the same basic function, that of a synthetic microbially biofilm maximizing substrate for the above stated purposes in the above stated manner and manipulation. The matrix material may include, for example, inert plastic/synthetic microbial substrate with no associated ionic or electric charge, material with a negative charge, material with a positive charge, organic and/or biodegradable material, plant based or biodegradable plastic, coconut coir matrix, and 3d printed matrix of varying materials with corresponding purposes (e.g., organic and/or inorganic, biodegradable and/or inert/permanent, metallic reactive or non-reactive alloy, fiberoptic, or transparent, translucent, opaque, etc.)

In some aspects, the coconut coir may be used for plugging holes or short-circuiting or as a disposable matrix that biodegrades after a few seasons of use. In various aspects, the coconut coir may be bonded together with waterproof adhesive to form a biodegradable panel that will last several years but may also break down when disposed of. This may reduce the overall volume of the waste piles/dumps.

In some aspects, 3d printed matrix can be printed at multiple scales for multiple purposes, such as, for example, separate or combined printing at nanoscopic, microscopic, and/or macroscopic levels of printing. In some aspects, a 3d printed matrix may include micron-scale to meter+ scale printing all within the same embodiment/panel. 3d matrix may be based on printable cad designs that can be printed in endless succession, scale, and position relevant to/or in positional relation to each other to create one printed copy/embodiment or millions, dependent on need, size, purpose, and vessel specifics. It should be appreciated that specific matrix purposes delineate specific form either singularly or combined within the same embodiment. In some aspects, the matrix 122 can range from highly flexible (e.g., seaweed), to amorphous (e.g., blob like structures with lots of stretching but a definite form when allowed to float freely), to stiff but flexible (e.g., bamboo), to totally rigid (e.g., like oak) that can support large loads.

An exemplary 3d printed matrix may include an artery/vein/capillary passage diameter structure modelled, for example, after a coronary system. Such a structure may provide initial directionality and volume at low pressure/high volume/low surface area (artery/influent) that then increases pressure and decreases speed through smaller channelized sections (capillaries) where biofilm surface area is maximized for treatment, before again being sped up by reduced pressure due to increased passage size (vein/effluent).

In some aspects, the matrix may include a wave-attenuating matrix, which is bulbous on the front, at all scales, and acts as a buffer to reduce wave force, and then channelizes flow into the embodiment. Such a structure may be used on a leading edge (i.e., facing influent) of panel.

According to various aspects, the matrix 122 may comprise a floating matrix with closed cell bubbles printed into the matrix that is for the purpose of buoyancy to create an embodiment that can float and support plant life on its top surface or as a way of supporting matrix curtains or matrix parachutes.

In some aspects, the 3d printed matrix may comprise a printable node looking like a buckeyball or a limpet mine or a long needled sea urchin that is attached at multiple points with other similar structure. The matrix may be a form having one or more scales and/or one or more sizes that are reprinted in a purposeful relation to one another to create volume and surface area.

It should be appreciated that a 3d matrix can be printed as one piece and/or as a plurality of pieces to be assembled afterwards (i.e., printed modules or one whole embodiment directly from the printer that is complete). The size and thickness of the 3d printed matrix may be based on the method of cleaning and the form of the pollutant. For example, panels printed for a nutrient reactor can be made thicker than panels destined for a dissolved metals reactor.

Negative or positively charged 3d printed matrix material may act as an initial bonding site before biofilm establishment. For example, a positively charged matrix material will reduce the polar bonds of biofilm to the matrix and only allow for the encasement, not the actual attachment, of the biofilm on the matrix. A negatively charged matrix material may work as an ionic bonding surface to attach biofilm to matrix directly.

In some aspects, the 3d printed matrix may comprise carbon fiber printed matrix for strength, flexibility, and durability. In some aspects, the 3d matrix may comprise a metallic reactive or non-reactive alloy matrix. In various aspects, the 3d printed matrix may comprise a fiberoptic matrix/transparent matrix, which may carry light from the top of a vessel to the inside for the purpose of creating a biological response by the microbes to the UV light that will then produce more extra cellular polysaccharide (EPS) and increase the overall biomass and bio-volume.

According to some aspects, the 3d printed matrix may comprise a translucent or opaque matrix that is treated to protect against UV damage, rubberized plastic polymer matrix for greater flexibility, or semi-permeable or slightly permeable matrix. In some aspects, the matrix may be made of hydrolysis catalyzing materials (e.g., based on Platinum or other cheaper material) for the purpose of creating O₂ in an embodiment where dissolved O₂ is limited by splitting water in to Oxygen and Hydrogen. O and H₂ are created passively by contact of water with the hydrolizing material that the matrix is made of, making it available for biotic respiration or abiotic oxidation.

Due to the oxidizing nature of a hydrolysing material, biofilm may find if hard to establish on the matrix material, so the hydrolysing material (e.g., platinum based or otherwise) should be printed in concert with standard matrix to provide both passive aeration and a suitable surface area for the biofilm. The addition of extra hydrogen ions through hydrolysis may require additional pH buffering using lime, caustic soda, or other pH shifting amendment.

It should be appreciated that a printable matrix may have the intentional characteristic of dissolution or biodegradation over a specific time frame. This intentional dissolving (like dissolvable stitches in the medical field) or biodegradation to the point that the matrix no longer supports the weight of the accumulated material is a method for saving space in an embodiments volume for accumulated material. This also gives the embodiment the ability to fill in all the available space and volume as the matrix dissolves for the purpose of material accumulation, and while 95% open volume for matrix is the norm, the additional volume may be needed or useful.

It should be appreciated that matrix in accordance with the present disclosure can be printed of any combination and/or composition (e.g., heterogeneous mix (either separately or combined while still within the same embodiment) or homogenous (all one individual material)). Matrix heterogeneity is only limited by the abilities of the 3d printer used.

It will be apparent to those skilled in the art that various modifications and variations can be made to the assemblies and methods for treating wastewater of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. An assembly for treating wastewater, comprising:
a vessel having an inlet configured to direct wastewater into the vessel and an outlet configured to direct treated water out of the vessel, the inlet and the outlet being at opposite ends of the longitudinal dimension of the vessel such that the wastewater generally flows in the longitudinal direction; and
at least one panel removably inserted into the vessel, the at least one panel extending substantially across a width dimension of the vessel, the width dimension being generally perpendicular to the longitudinal dimension, the panel comprising a biofilm-coated matrix that permits the flow of wastewater through the panel,
wherein the vessel and panel are sized and arranged such that the wastewater is exposed to the biofilm-coated matrix for a time sufficient to remove a desired metal from the wastewater.

2. The assembly according to claim 1, further comprising a heat exchange assembly configured to conduct heat energy from heated effluent water to a bottom and/or side of the vessel.

3. The assembly according to claim 2, wherein the heat exchange assembly includes effluent pipes buried in the ground or concrete below and/or adjacent to the vessel.

4. The assembly according to claim 1, wherein the vessel includes a man-made container or a natural occurring trench.

5. An method for treating wastewater, comprising:
removably inserting at least one panel into a vessel, the at least one panel extending substantially across a width dimension of the vessel, the panel comprising a biofilm-coated matrix that permits the flow of wastewater through the panel;
directing wastewater into the vessel;
treating the wastewater, while in the vessel, by directing the wastewater in a longitudinal direction through the at least one panel, the longitudinal direction being generally perpendicular to the width dimension; and
directing treated water out of the vessel,
wherein the vessel and panel are sized and arranged such that the wastewater is exposed to the biofilm-coated matrix for a time sufficient to remove a desired metal from the wastewater.

6. The method according to claim 5, further comprising directing heated effluent to flow adjacent to a bottom or side of the vessel such that the heated effluent exchanges its heat energy with cooler influent in the vessel.
